(19) United States
(12) Patent Application Publication
(10) Pub. No.: US 2010/0315994 A1
(43) Pub. Date: Dec. 16, 2010

(54) PARTICIPANT RESPONSE SYSTEM WITH FACILITATED COMMUNICATIONS BANDWIDTH

(75) Inventor: Clinton Lam, Calgary (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: SMART TECHNOLOGIES ULC, Calgary, Alberta (CA)

(21) Appl. No.: 12/522,818

(22) PCT Filed: Jan. 10, 2008
(86) PCT No.: PCT/CA08/00033

§ 371 Date: Sep. 1, 2010

(51) Int. Cl. H04W 40/00

(52) U.S. Cl. 370/328

(57) ABSTRACT

A participant response system (50) comprises at least one host computer (52) and a plurality of remote units (62) communicating wirelessly with the host computer using a radio packet protocol. During communications between the host computer (52) and the remote units (62), data messages from the host computer (52) to be processed by substantially all of the remote units (62) are transmitted to the remote units in general broadcast frames (BF) destined for all of the remote units and data messages from the host computer (52) to be processed by selected ones of the remote units (62) are transmitted to the selected ones of the remote units in message frames destined for those selected ones of the remote units (62) outside of the period of each general broadcast frame. Data messages from remote units (62) destined for the host computer (52) are also transmitted in message frames beyond the period of each general broadcast frame.

### RELATED APPLICATIONS

This application claims the benefit of U.S. Provisional Patent Application Ser. No. 60/879,580 to Lam filed on Jan. 10, 2007 entitled “Participant Response System With Reduced Communication Bandwidth”, the content of which is incorporated herein by reference.

### FIELD OF THE INVENTION

The present invention relates generally to a participant response system and in particular to a participant response system with facilitated communications bandwidth.

### BACKGROUND OF THE INVENTION

Participant response systems for enabling participants of an event or assessment to enter responses to posed questions, motions or the like are well known in the art and have wide applicability. For example, during a conference, seminar or the like, participants can be provided with handsets that enable the conference participants to respond to questions, or to vote on motions raised during the conference or seminar. In the entertainment field, audience members can be provided with handsets that enable the audience members to vote for entertainment programmes or sporting events. These participant response systems are also applicable in the field of education. Students can be provided with handsets that enable the students to answer questions posed during lessons, tests or quizzes. Of significant advantage, these participant response systems provide immediate feedback to presenters, teachers, entertainment programme producers, or event organizers. With respect to the field of education, research shows that teachers teach better and students learn better when there is rapid feedback concerning the state of students' comprehension or understanding. It is therefore not surprising that such participant response systems are gaining wide acceptance in the field of education.

Participant response systems fall generally into two categories, namely wired and wireless participant response systems. In wired participant response systems, the remote units used by participants to respond to posed questions or to vote on motions are typically physically connected to a local area network and communicate with a base or host computer. In wireless participant response systems, the remote units used by participants to respond to posed questions or to vote on motions communicate with the host computer via wireless communication links. Whether wired or wireless, many different types of participant response systems have been considered.

For example, U.S. Pat. No. 2,465,976 to Goldsmith discloses a centercasting network system for polling public opinion by means of radio apparatus installed in numerous outlying voting stations. Groups of outlying voting stations communicate with associated central stations where votes that are obtained by the voting stations are counted or tabulated in accordance with any desired classification of votes. The voting stations gather and store voters' choices in a tangible medium. All of the voting stations within a given group then transmit the stored votes sequentially to the central station that serves the particular group. The total votes are stored at each central station until a master station transmits a start signal to the central station. The central station then transmits the results to the master station sequentially.

U.S. Pat. No. 3,858,212 to Tompkins et al. discloses a multi-purpose information gathering and distribution system comprising a central station having an omni-directional antenna for transmitting information queries to a plurality of remote stations and for gathering data acquired at the remote stations that is returned to the central station by the remote stations in response to the information queries. The remote stations are sequentially queried by the central station. In response to the information query, each remote station transmits the conditions at the remote station together with a remote identification code to the central station.

U.S. Pat. No. 4,247,908 to Lockhart, Jr et al. discloses a two-way communication system for use with a host computer that includes a control unit, a base station and multiple, hand-held, portable radio/data terminal units. The control unit interfaces directly with the host computer but uses a radio link to interface with the portable radio/data terminal units. Each portable radio/data terminal unit includes a two-way radio and a data terminal. The data terminal includes a keyboard for data entry and an LED display for readout of either received data or locally generated data. The host computer initiates communication through polling and/or selection of portable radio/data terminal units via the control unit. The control unit, in response to a “poll” from the host computer, answers by sending either a previously received message from a portable radio/data terminal unit, or if no message has been received, a “no message” response. Polling by the control unit is an invitation to the portable radio/data terminal units to send data to the control unit to be stored, grouped if necessary and sent on to the host computer. The control unit polls the portable radio/data terminal units by address in a particular sequence. The control unit transmits acknowledgements to the portable radio/data terminal units for received data on the next polling cycle.

U.S. Pat. No. Re. 35,449 to Derks discloses a remote response system comprising a central control unit that transmits a plurality of distinct address words to remotely located response units and a receiver that receives data words transmitted from response units. Each response unit includes user operable data entry means and a receiver for receiving address words transmitted from the central control unit. Each response unit also includes circuit means for identifying an address word unique to the particular response unit and a transmitter for transmitting data words to the central control unit in response to identification of its unique address word. The central control unit comprises means for determining that a valid data word has been received from a response unit and for transmitting an acknowledge message to the response unit that sent the valid word. In response to the received acknowledge message, the particular response unit is conditioned to a second, or “off” mode. When a response unit has been placed in the “off” mode, the response unit will not respond to its address word again until a new user selection is made.

U.S. Pat. No. 5,002,491 to Abrahamson et al. discloses an interactive electronic classroom system for enabling teachers to teach students concepts and to receive immediate feedback regarding how well the students have learned the taught concepts. Structure is provided for enabling students to proceed in lockstep or at their own pace through exercises and quizzes, responding electronically to questions asked, the teacher being able to receive the responses, and to interpret a readout of student responses in histogram or other graphic display form. The electronic classroom comprises a central computer and a plurality of student computers, which range from simple devices to full fledged personal computers, connected to the central computer over a network. Optional peripheral hardware, such as video cassette recorders (VCRs) or other recording/reproducing devices, may be used to provide lessons to students in association with the computer network.

U.S. Pat. No. 5,724,357 to Derks discloses a wireless remote response system comprising a base unit which retrieves user-entered responses from a plurality of remote response units, each of which is provided to a user. The base unit transmits a base data package over a wireless communication link to the plurality of remote response units, which decode the base data packet and load into memory a portion of the decoded base data package at each response unit. Each response unit examines the characters loaded into the memory and determines and processes the characters that pertain to that particular response unit.

U.S. Pat. No. 6,028,866 to Engel et al. discloses a system comprising a central apparatus and at least three end apparatuses. Each end apparatus communicates bi-directionally with the central apparatus preferably over an infrared wireless communication link. Each end apparatus is a hand-held game or personal digital assistant (PDA) and comprises a display, keypad and sending and receiving means. In one embodiment, the end apparatuses communicate with the central apparatus using message frames. In an alternative embodiment, broadcast frames are used to exchange messages.

U.S. Pat. No. 6,302,698 to Ziv-El discloses a networked teaching and learning system comprising a plurality of student computers, a network server and at least one teacher's computer. The at least one teacher's computer includes comparison and evaluation logic in communication with the student computers for comparing and evaluating each student keystroke with the characters of an answer, if any, immediately after every student keystroke. The teaching and learning system provides character-by-character evaluation for quick learning feedback for students, as well as simultaneous observation at the teacher's computer of multiple student responses identified as correct or incorrect. The teaching and learning system enables quick construction of various exercise types, the scoring of unanticipated responses, and the introduction of an explanation component in addition to a direct response to a question.

U.S. Pat. No. 6,790,045 to Drimmer discloses a method and system for analyzing student performance by classifying student performance into discrete performance classifications associated with corresponding activities related to an electronic course. An observed student performance level for at least one of the performance classifications is measured. A benchmark performance level or range is established for one or more of the performance classifications. It is then determined whether the observed student performance level is compliant with the established benchmark performance level for the at least one performance classification. Instructive feedback is determined for the observed student based upon any material deviation of the observed student performance from at least one benchmark.

U.S. Patent Application Publication No. 2004/0033478 to Knowles et al. discloses a participant response system comprising a plurality of wireless handsets assigned to participants of an event. Each handset has a keyboard for allowing a participant to input a response and has audio capability to allow the participant to receive and input audio. Each handset is configurable either as a participant response handset to allow a participant to enter a response, or as a base station.

U.S. Patent Application Publication No. 2004/0072136 to Roschelle et al. discloses a method and system for assessing a student's understanding of a process that may unfold over time and space. The system comprises thin client devices in the form of wireless, hand-held, palm-sized computers that communicate with a host workstation. The system provides a sophisticated approach of directing students to perform self-explanation, and enables instructors to enhance the value of this pedagogical process by providing meaningful and rapid feedback in a classroom setting.

U.S. Patent Application Publication No. 2004/0072497 to Buehler et al. discloses a response system and method of retrieving user responses from a plurality of users. The response system comprises a plurality of base units and a plurality of response units. Each of the response units is adapted to receive a user input selection and to communicate that user's input selection with at least one base unit utilizing wireless communication. Personality data is provided for the response units to facilitate communication with a particular base unit. The personality data of a particular response unit is changed when it is desired to change the base unit to which that response unit communicates. This allows a response unit to become grouped with a particular base unit at a particular time and to become grouped with another base unit at another particular time.

U.S. Patent Application Publication No. 2006/0218572 to Thielman et al. discloses an audience response system comprising a host unit, presenter device and a plurality of audience response units with keypads. The host unit is communicatively coupled to a computer. The audience response units check-in to the host unit based on adjustable check-in times that are updated and adjusted by the host unit and transmitted to the audience response units. In one embodiment, during the beacon window various types of information are transmitted from the host unit to the audience response units such as a synchronization signal and a global message (e.g. question signals). The audience response units can then transmit during the beacon period in the contention access period.

Although the above participant response systems allow information to be communicated to a host computer or base unit using remote units, time-division multiplex schemes have been commonly employed for such communications. As is known, in a time-division multiplex scheme, each remote unit is assigned a dedicated time slot for data communication with the host computer. The host computer cycles through the remote units one at a time in accordance with the assigned time slots to send and receive data. Unfortunately, because the timeslot is dedicated and assigned during participant response system negotiation, the timeslot assigned to one remote unit cannot be shared with another remote unit even if the one remote unit has no data to send to the host computer. As will be appreciated, this results in wasted communications bandwidth resources.

It is therefore an object of the present invention at least to provide a novel participant response system with facilitated communications bandwidth.

### SUMMARY OF THE INVENTION

Accordingly, in one aspect there is provided in a participant response system comprising at least one host computer and a plurality of wireless, remote units communicating wirelessly with said host computer using a radio packet protocol, a method of reducing communications bandwidth during transmission of data messages between said host computer and said remote units, said method comprising:

bundling data messages destined for substantially all remote units in general broadcast frames and transmitting said general broadcast frames to all of said remote units for processing by said remote units;

transmitting data messages destined for one or more selected remote units in message frames addressed to said one or more selected remote units asynchronously; and

transmitting data messages from remote units destined for said host computer in message frames asynchronously.

In one embodiment, the general broadcast frames are transmitted at generally equal intervals that are equal to or less than about 300 ms. The general broadcast frames in one form are synchronization frames such as beacon frames in accordance with the beacon mode defined by the IEEE802.15.4 specification.

In one embodiment, the bundled data messages are destined for all of the remote units and the message frames are transmitted according to a carrier sensed, multiple access and collision avoidance scheme. During the bundling at least one of command messages and status messages are bundled into the general broadcast frames. Each command message may be selected from the group comprising log-in messages, log-out messages, log-in grant messages, question download messages, answer download messages, answer upload messages, hands-up messages, test start messages and test end messages. Each status message may be selected from the group comprising remote unit status messages, network status messages and personal area network (PAN) ID messages.

According to another aspect there is provided a method of transmitting data messages between a base unit and a plurality of hand-held units over a wireless communications link, said method comprising:

embedding data messages addressed to substantially all of said hand-held units into synchronization frames and broadcasting the synchronization frames at intervals to said hand-held units;

transmitting data messages addressed to selected hand-held units in message frames asynchronously; and

transmitting data messages from remote units addressed to said host computer in message frames asynchronously.

According to yet another aspect there is provided in a system comprising a base unit and a plurality of remote units communicating wirelessly with said base unit, a data transmission method comprising:

examining each data message to be transmitted by said base unit to determine if the data message is to be processed by substantially all of said remote units;

if so, incorporating the data message into a synchronization frame destined for transmission to all of said remote units and transmitting said synchronization frame;

if not, transmitting the data message in a message frame addressed to the remote unit(s) that is(are) to process the data message asynchronously; and

transmitting the response data message(s) from the remote unit(s) addressed to said host computer in a message frame asynchronously.

According to still yet another aspect there is provided a participant response system comprising:

at least one host computer; and

a plurality of remote units communicating wirelessly with said host computer using a radio packet protocol, wherein during communications between said host computer and said remote units, data messages from said host computer to be processed by substantially all of said remote units are transmitted to said remote units in general broadcast frames destined for all of said remote units and data messages from said host computer to be processed by selected ones of said remote units are transmitted to the selected ones of said remote units in message frames destined for those selected ones of said remote units asynchronously and wherein data messages from said remote units to be processed by said host computer are transmitted in message frames asynchronously.

### BRIEF DESCRIPTION OF THE DRAWINGS

Embodiments will now be described more fully with reference to the accompanying drawings in which:

FIG. 1 is a top plan view of a classroom employing a participant response system;

FIG. 2 is a schematic view of the participant response system of FIG. 1;

FIG. 3 is a schematic view of an interactive whiteboard forming part of the participant response system of FIGS. 1 and 2;

FIGS. 4a and 4b are side elevational and top plan views respectively, of a receiver forming part of the participant response system of FIGS. 1 and 2;

FIG. 5 is a schematic block diagram of the receiver of FIGS. 4a and 4b;

FIG. 6 is a front plan view of a remote unit forming part of the participant response system of FIGS. 1 and 2;

FIG. 7 is an enlarged front plan view of the remote unit display;

FIG. 8 is a schematic block diagram of the remote unit of FIG. 6;

FIGS. 9 and 10 show a student roster;

FIG. 11 shows beacon frames generated at intervals; and

FIG. 12 shows a test question displayed on the touch surface of the interactive whiteboard of FIG. 3.

### DETAILED DESCRIPTION OF THE EMBODIMENTS

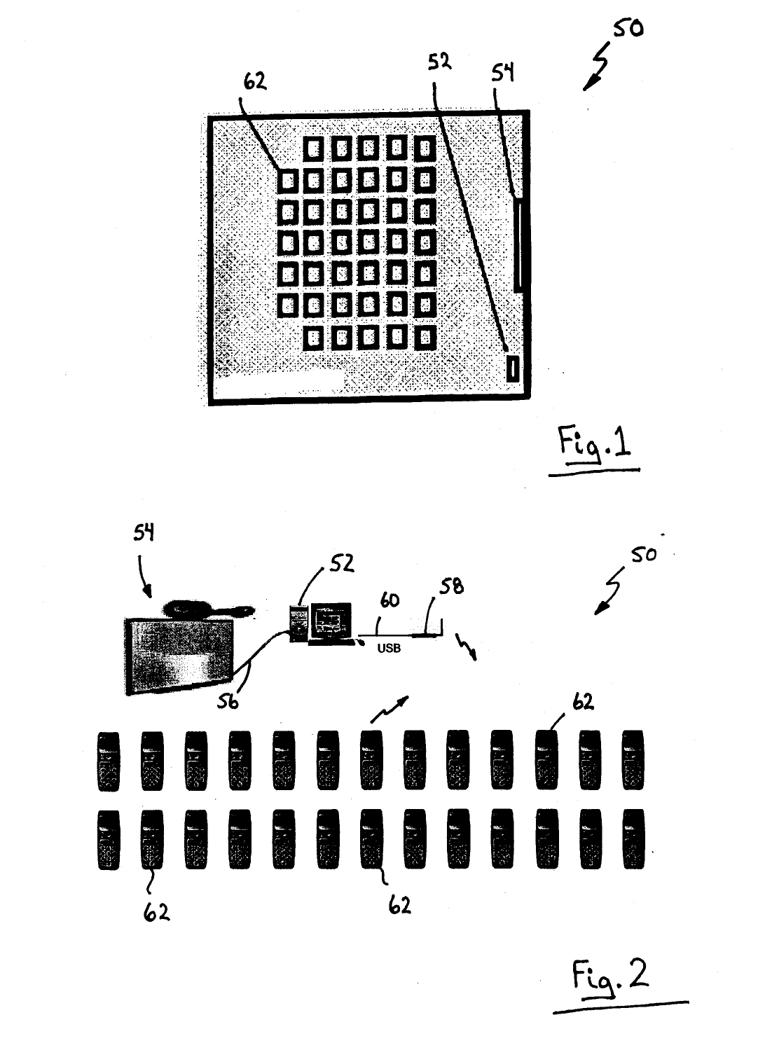

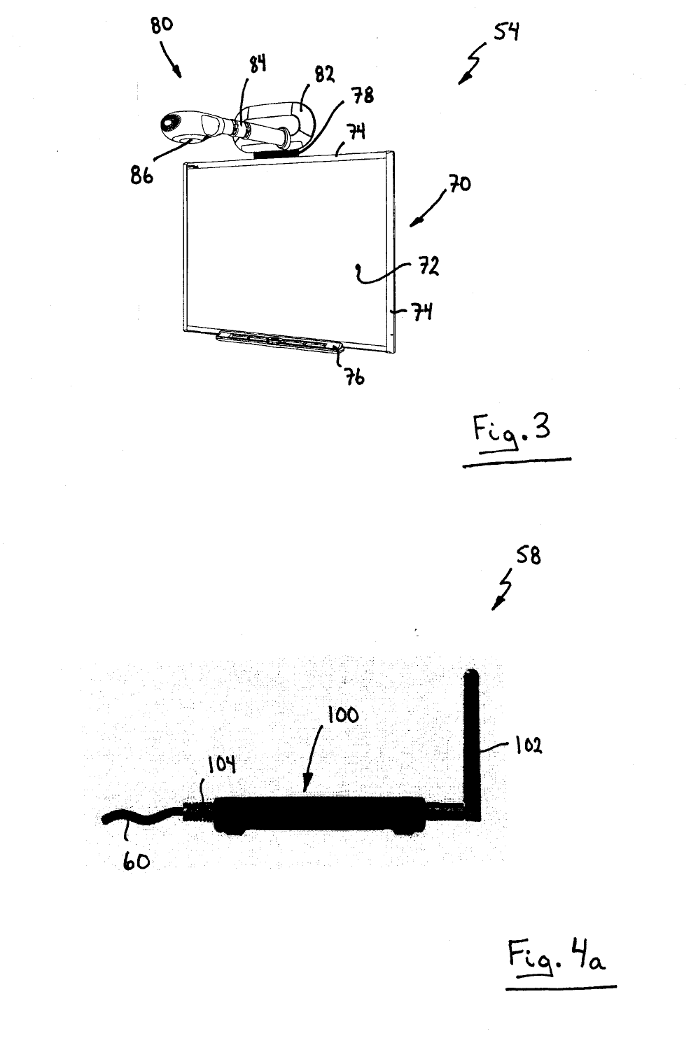

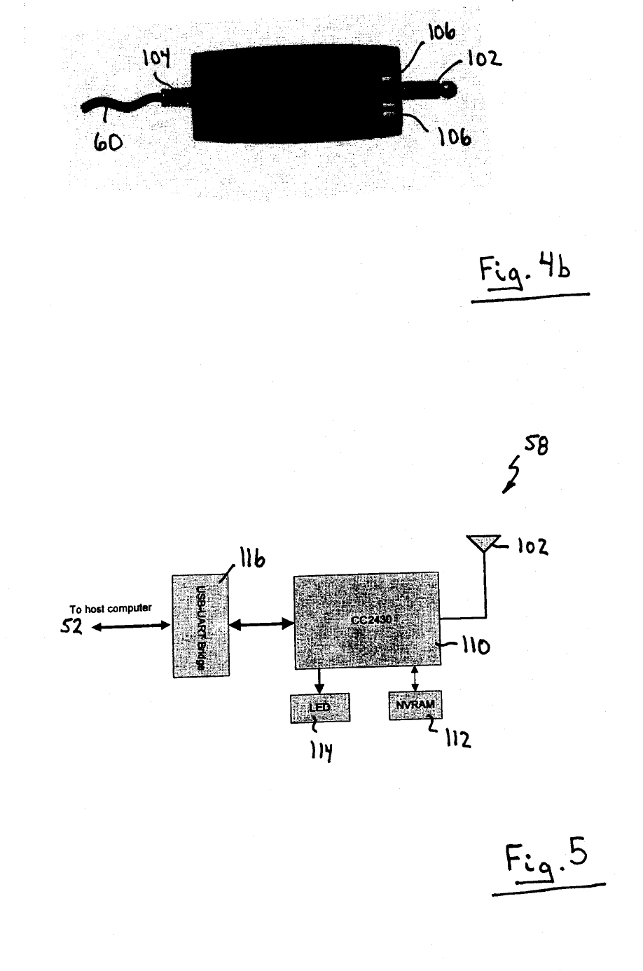

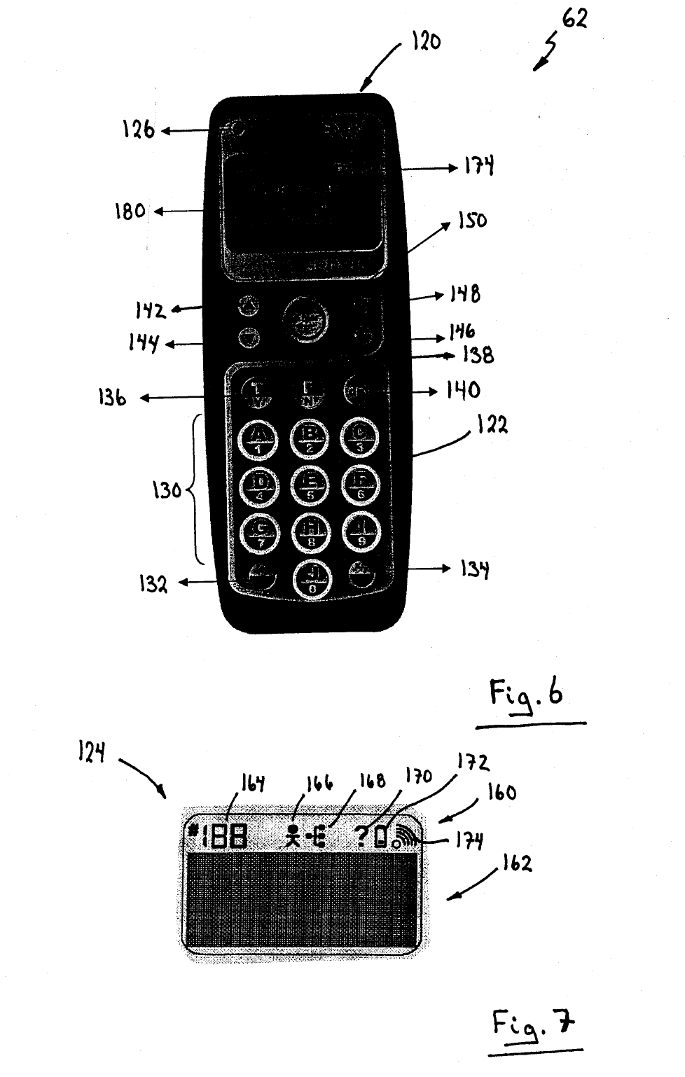

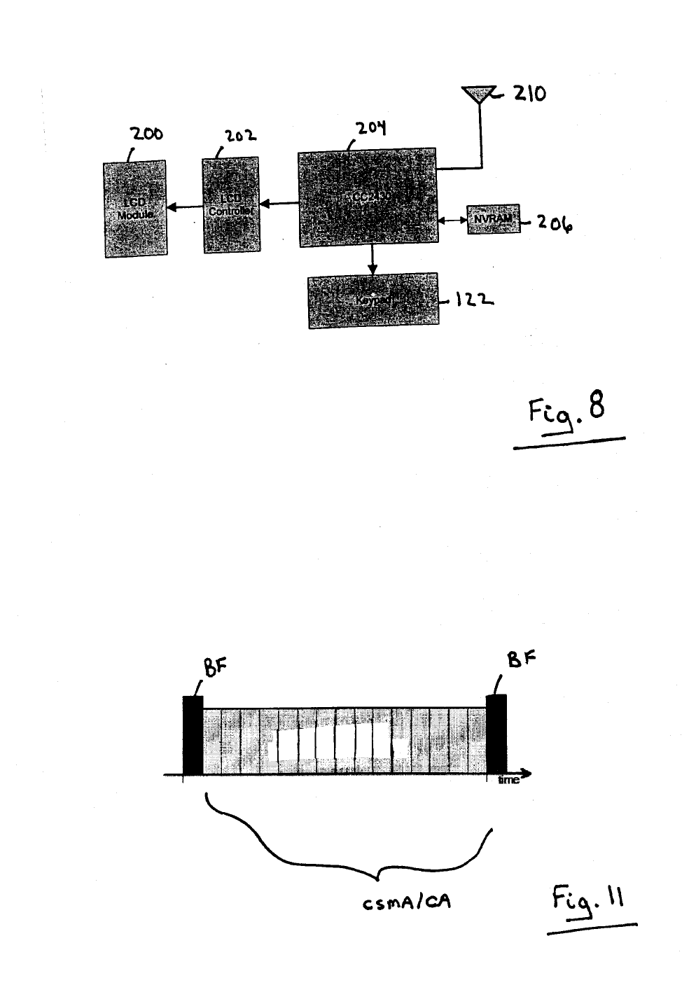

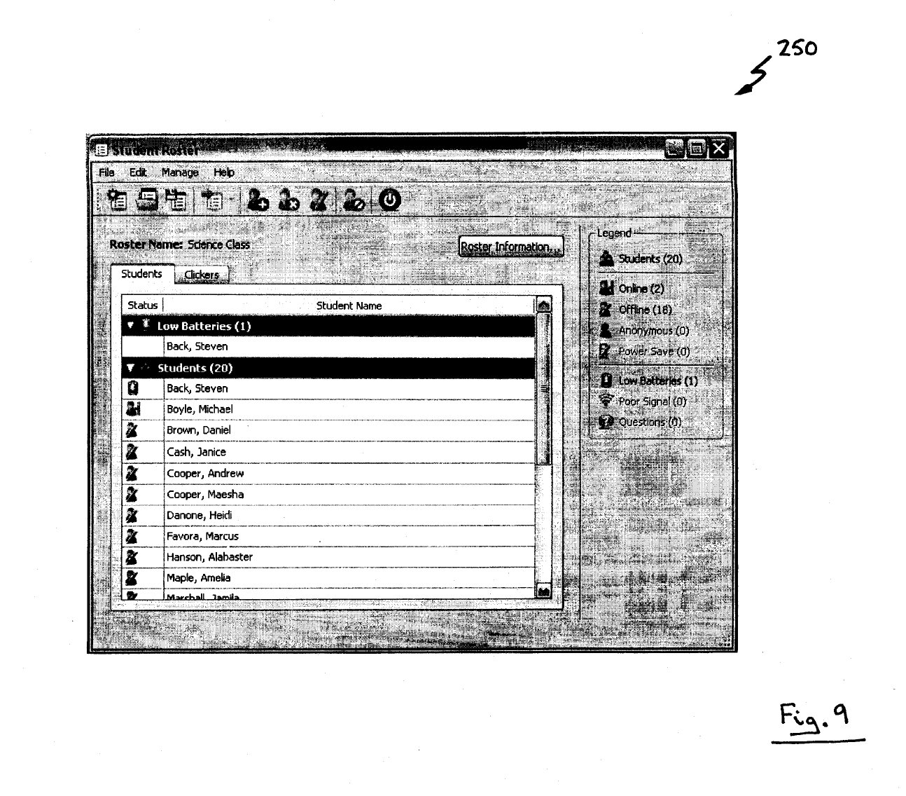

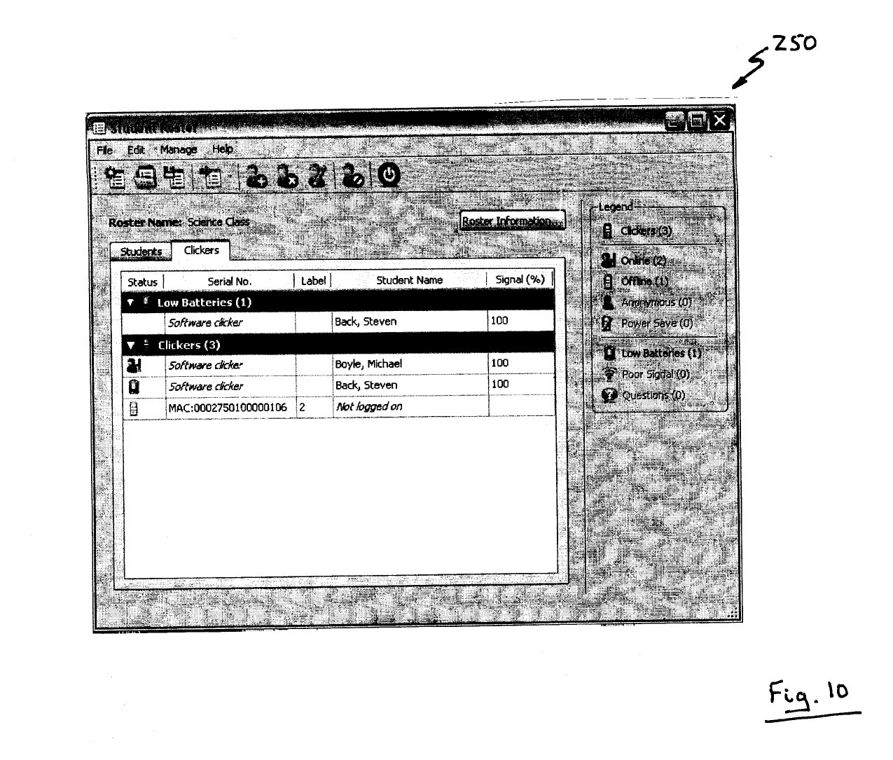

Turning now to FIGS. 1 and 2, a participant response system is shown and is generally identified by reference numeral 50. In this embodiment, participant response system 50 is employed in a classroom, lecture hall or theatre of an educational institution such as for example a school, university, college or the like and is used to create tests, quizzes or assessments (“tests”), administer created tests to a class of students and analyze the results of administered tests. As can be seen, the participant response system 50 comprises a base unit or host computer 52, an interactive whiteboard (IWB) 54 physically connected to the host computer 52 via a cable 56, a radio frequency (RF) receiver 58 physically connected to the host computer 52 via a universal serial bus (USB) cable 60, and a plurality of wireless, hand-held remote units 62 communicating with the host computer 52 over a wireless communications link via the receiver 58.

The participant response system firmware in this embodiment is implemented on top of IEEE802.15.4 media access control (MAC) protocol layer software provided by Texas Instruments (TI). The TI MAC protocol layer software comprises a small real-time kernel and a call Z-stack operating system (OS) to provide simple real-time OS facilities such as for example, timer management, task management and interrupt management. Abstraction layers are used to separate the OS and the hardware drivers for ease of porting to a different OS and hardware platform.

In this embodiment, the IWB 54 is a 600i series interactive whiteboard manufactured by SMART Technologies ULC, of Calgary, Alberta, Canada, assignee of the subject application. As is best seen in FIG. 3, the IWB 54 comprises a large, analog resistive touch screen 70 having a touch surface 72. The touch surface 72 is surrounded by a bezel 74. A tool tray 76 is affixed to the bezel 74 adjacent the bottom edge of the touch surface 72 and accommodates one or more tools that are used to interact with the touch surface. The touch screen 70 is mounted on a wall surface via a mounting bracket 78. A boom assembly 80 is also mounted on the wall surface above the touch screen 70 via the mounting bracket 78. The boom assembly 80 comprises a speaker housing 82 accommodating a pair of speakers (not shown), a generally horizontal boom 84 extending outwardly from the speaker housing 82 and a projector 86 adjacent the distal end of the boom 84. The projector 86 is aimed back towards the touch screen 70 so that the image projected by the projector 86 is presented on the touch surface 72.

Turning now to FIGS. 4a, 4b and 5, the receiver 58 is better illustrated. As can be seen, the receiver 58 comprises a casing 100 adapted to be desktop or wall mounted. An L-shaped omni-directional antenna 102 is mounted on the front end of the casing 100. The rear end of the casing 100 receives the USB cable 60. A plurality of light emitting diodes (LEDs) 106 is provided on the top surface of the casing 100. During operation of the receiver 58, the LEDs 106 are illuminated to provide visual feedback concerning the operational status of the receiver 58. In this embodiment, the LEDs 106 comprise a power status LED and communications status LEDs. Alternatively, the receiver 58 may provide visual feedback via a display such as a liquid crystal display (LCD) or via both LEDs and an LCD. The receiver electronics are accommodated by the casing 100 and comprise a microprocessor 110 that communicates with non-volatile, random access memory (NVRAM) 112, an LED driver 114 and a USB-UART bridge 116. Power is provided to the receiver 58 via the USB cable connection 60.

One of the remote units 62 is best shown in FIGS. 6 to 8. As can be seen, the remote unit 62 comprises a casing 120 having a keypad 122, an LCD or other suitable display 124, a power button 126 and an optional battery status LED (not shown) on its front surface. In this embodiment, keypad 122 comprises ten (10) dual character (A to J/0 to 9) buttons 130, a plus/minus (+/−) button 132, a fraction/decimal ((x/y)/*) button 134, a true/yes (T/Y) button 136, a false/no (F/N) button 138, a delete (del) button 140, up and down scroll (̂/v) buttons 142 and 144, a menu button 146, a question/hands up (?) button 148 and an enter button 150. Those of skill in the art will appreciate that the form of the keypad shown in FIGS. 6 to 8 is exemplary. The keypad may of course comprise an alternate set of keys, a full QWERTY or DVORAK key set or a subset thereof. If desired, the entire physical keypad or a portion thereof may be replaced with a touch screen overlying the LCD display to allow a user to interact with virtual keys.

The display 124 comprises an upper row of LCD icons 160 disposed above a character display area 162. The LCD icons 160 comprise a question number icon 164, a user status icon 166, a network status icon 168, a hands-up (?) icon 170, a battery status icon 172 and a transmission status icon 174. The character display area 162 comprises a 128×48 pixel array that is divided into three lines 180. Each line 180 can display a total of sixteen (16) characters. Remote unit electronics are accommodated by the casing 120 and comprise an LCD controller 200 that communicates with the display 124, an LCD driver 202 that drives the LCD controller 200, a microprocessor 204 that communicates with the LCD driver 202 and the keypad 122, as well as with NVRAM 206 and a printed circuit board, omni-directional antenna 210. Power is provided to the remote unit 62 by non-rechargeable or rechargeable batteries (not shown) accommodated by the casing 120.

The host computer 52 runs participant response application software comprising a session manager that maintains the state of the participant response system 50. In particular, the session manager maintains a student roster 250 as shown in FIGS. 9 and 10. The student roster 250 identifies the class name, the students in the class by first and last name, the log-in status of the students and whether any of the logged-in students are using a remote device 62 that has a low battery level. The manner by which remote unit battery levels are determined is described in co-pending U.S. patent application Ser. No. ______ (Not Available) to Doerksen et al. entitled “Participant Response System Employing Battery Powered, Wireless Remote Units” filed on even date herewith and assigned to the assignee of the subject application, the content of which is incorporated herein by reference.

The session manager is responsible for downloading the question answer formats e.g. true/false, yes/no, multiple choice, numerical etc. for the questions of the test being administered, to the remote units 62, for receiving answers to questions input by students using the remote units 62 and for keeping track of the question each student is answering. The session manager is also responsible for aggregating answers to questions received from students into results, and grading the answers to the questions.

The host computer 52 also runs SMART Notebook™ whiteboarding software to facilitate interaction with the IWB 54. As a result, the display output of the host computer 52 is conveyed to the IWB 54 and is used by the projector 86 to present an image on the touch surface 72. Pointer interactions with the touch surface 72 are detected by the touch screen 70 and conveyed to the host computer 52. The display output of the host computer 52 is in turn adjusted by the host computer to reflect the pointer activity. The host computer 52 and IWB 54 thus form a closed-loop. Depending on the nature of the pointer activity, the host computer 52 may treat the pointer contacts as writing or erasing or may treat the pointer contacts as mouse events and use the mouse events to control execution of application programs, such as for example the participant response notebook application, executed by the host computer 52. In this manner, the IWB 54 can be used by the instructor to create and administer tests and to analyze test results.

In addition, the participant response application software comprises an administration application that provides a graphical user interface for the session manager to allow the instructor to define and refine test questions, create tests using defined questions, start and stop tests and visualize test results. The administration application also allows question definitions to be imported, allows responses, grades and results to be exported and allows tests to be printed together with answer keys. The administration application has two modes of operation, namely a Notebook integrated mode and a stand-alone mode. In the Notebook integrated mode, the administration application is integrated into the SMART Notebook™ software. The stand-alone mode is used when the participant response system 50 includes a different brand of IWB 54 or does not include an IWB.

In this embodiment as shown in FIG. 2, the host computer 52, IWB 54 and receiver 58 are physically connected by cables 56 and 60. Messages exchanged between the host computer 52, IWB 54 and receiver 58 are structured using extensible markup language (XML) over HTTP. The receiver 58 and the remote units 62 communicate over a wireless radio frequency (RF) communications network. The microprocessor 110 of the receiver 58 thus provides both a USB interface and an RF interface and runs a service that translates messages in USB protocol to messages in radio frequency (RF) wireless protocol and vice versa as well as runs IEEE802.15.4 MAC layer software to manage the IEEE802.15.4 network thereby to permit the host computer 52 and remote units 62 to communicate. Messages exchanged between the session manager and the receiver 58 comprise a header, a command identification, message bytes and a checksum. Consistent overhead byte stuffing is employed to provide frame delimiting of packets thereby to facilitate the determination of the start and end of command packets. Messages exchanged between the receiver 58 and the remote units 62 do not include the header and the checksum as the IEEE802.15.4 protocol is used to handle packet addressing and ensure packet integrity.

The messages exchanged between the session manager, the receiver 58 and the remote units 62 include diagnostic messages, status messages and command messages. For example, in this embodiment diagnostic messages comprise, but are not limited to, firmware information query messages, remote unit transmit power query messages and channel identification query messages. Status messages comprise, but are not limited to, remote unit status messages, network status messages and personal area network (PAN) ID messages. Command messages comprise, but are not limited to, log-in messages, log-out messages, log-in grant messages, question download messages, answer upload messages, hands-up messages, test start messages and test end messages.

In this embodiment, wireless communications between the host computer 52 and the remote units 62 are carried out according to the IEEE802.15.4 specification, which is particularly useful in wireless networks employing low cost, battery operated devices that have low data rates, consume low power and use the ISM band at 2.4 GHz.

In order to synchronize the participant response system 50, the participant response system 50 in this embodiment uses the beacon mode defined by the IEEE802.15.4 specification. The host computer 52 in this case acts as the coordinator and causes the receiver 58 to generate beacon frames at short intervals to wake up the remote units 62. Typically, the beacon frames are transmitted at least every 300 ms. Of course shorter or longer frame rates can be employed. In addition to the synchronization data in the beacon frames, which advise the remote units 62 when the next beacon frame will be generated, the beacon frames comprise information concerning the network such as for example, the PAN ID, the MAC address of the coordinator etc. together with data messages that are common to substantially all of the remote units 62. Such data messages include command and status messages such as for example, start test messages, end test messages, question download messages and remote unit status messages. As will be appreciated since common data messages processed by all of the remote units 62 are bundled, embedded or otherwise incorporated into the beacon frames, which are required for participant response system synchronization purposes and which are broadcast to all remote units 62 simultaneously, bandwidth is saved as the need to transmit data messages destined to all remote units individually to each of the remote units 62 is eliminated.

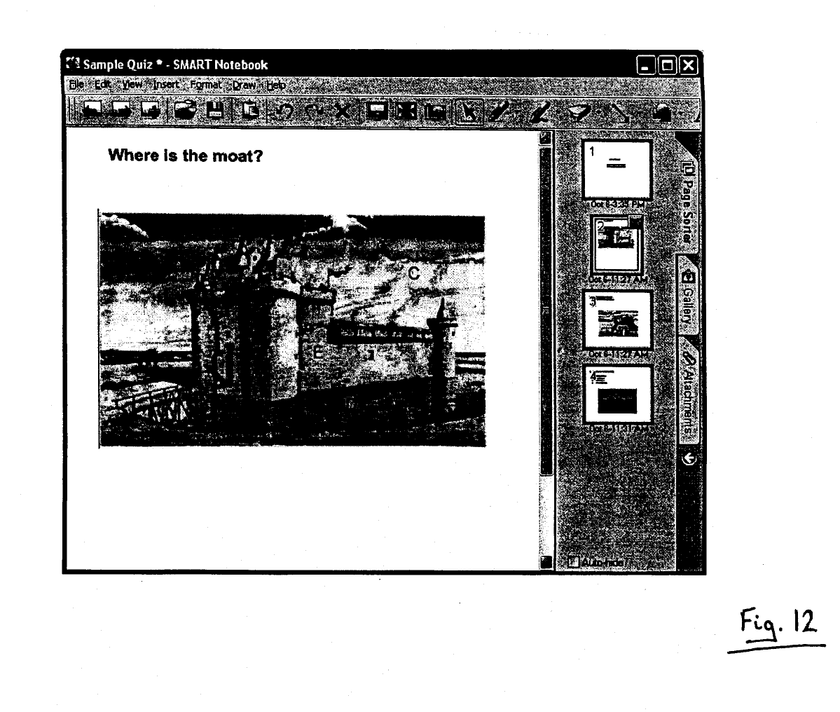

Communications between the receiver 58 and the remote units 62 outside of the period of the beacon frames BF makes use of a carrier-sensed, multiple access and collision avoidance scheme (CSMA/CA) and is asynchronous so no coordination between the remote units in terms of data transmission is required (see FIG. 11). According to this scheme as is well known in the art, when a remote unit 62 has a data message to send to the host computer 52 or when the receiver 58 has a data message to send to a particular remote unit 62 or to a particular subset of remote units 62 (i.e. a non-general broadcast message in the case of the receiver 58) before the remote unit 62 or the receiver 58 transmits the data message in a message frame, the remote unit/receiver listens to the channel for a defined duration to check for activity on the channel. If the channel is idle, the remote unit/receiver transmits the message frame. If the channel is busy, the remote unit/receiver defers transmission of the message frame until a subsequent check reveals an idle channel.

When a test is being administered to students, the session manager generates one or more question download messages that include the question answer formats for the questions of the test. The question download messages are then sent to the receiver 58, which in turn embeds the question download messages in the next beacon frame and broadcasts the beacon frame embodying the question download messages to all of the remote units 62 simultaneously. Upon receipt of the beacon frame, each active remote unit 62 in turn loads the question download messages into memory 206. The student associated with each remote unit 62 can then use the scroll buttons 142 and 144 to select the question to which the student wishes to respond so that the question answer format for the selected question is displayed. The host computer 52 also provides display data to the IWB 54 resulting in the projector 78 projecting the questions of the test on the touch surface 72 of the touch screen 70. In this embodiment, each question is displayed on the touch surface 70 independently as shown in FIG. 12 thereby to facilitate viewing by the students.

When the question is a true/false type question, the question answer format corresponding to the question that is displayed by the remote units 62 provides true and false selections. In this case, the question can be answered using either the true/yes button 136 or the false/no button 138. Likewise, when the question is a yes/no type question, the question answer format corresponding to the question that is displayed by the remote units 62 provides yes and no selections. In this case, the question can be answered using either the true/yes button 136 or the false/no button 138. When the question is a multiple choice or numeric type question, the question answer format corresponding to the question that is displayed by the remote units 62 provides choice selections or a line for the numeric answer. In this case, the question can be answered using the dual character buttons 130, the +/−button 132 and/or fraction/decimal button 134.

When an answer has been input into a remote unit 62 via the keypad 122 and the enter button 150 has been pressed, the remote unit 62 generates an answer upload message that includes the question number and the student's answer and sends the answer upload message in a message frame to the receiver 58, which in turn passes the message frame to the host computer 52. The session manager saves the answer upload message in the message frame and analyzes the answer thereby to provide results to the administration application.

If desired, the processing capabilities of the remote units 62 can be utilized to grade input answers. In this situation, in addition to command download messages, answer download messages are conveyed to the remote units 62. When a user inputs an answer to a question, the remote unit 62 compares the input answer with the corresponding answer download message and generates an answer upload message comprising one of two values signifying either a correct or incorrect response. As a result, some of the computing load is transferred to the remote units 62 reducing the processing burden placed on the host computer 52. If the system is configured for a practice mode, the remote unit can use the answer download messages to display the results to the user without transmitting answer upload messages to the host computer.

Although the participant response system 40 is described as using the beacon mode, it will be appreciated by those of skill in the art that the non-beacon mode defined by the IEEE802.15.4 specification may be employed. In this case, message broadcasting and synchronization is carried out at the application layer instead of the MAC layer.

The participant response system configuration specifics described above are exemplary and as will be appreciated by those of skill in the art, variations are possible. For example, the receiver 58 and remote units 62 can communicate according to the ZigBee specification. The receiver 58 and the host computer 52 can communicate over other wired communication links such as RS-232 or Ethernet connections or over a wireless communication link. Alternatively, the receiver 58 may be integrated into the host computer 52 such that the host computer 52 and remote units 62 communicate directly over a wireless communication link via a compatible wireless protocol such as for example Zigbee, Z-Wave, ANT, IEEE802.11b/g/n or Bluetooth™.

Although a particular form of remote unit 62 is illustrated and described those of skill in the art will appreciate that the remote units may take a variety of forms. For example, the remote units 62 may be cellular phones, personal digital assistants (PDAs), ultra-mobile personal computers, laptop computers or other suitable devices that allow users to input responses to questions. Of course, combinations of the above devices are permissible so that each user is not required to use the same input device.

Although the IWB 54 is described as including an analog resistive touch screen 70, those of skill in the art will appreciate that other types of touch screens, such as for example camera-based, surface acoustic wave, capacitive, electromagnetic etc. touch screens may be used. Alternatively, the questions can be projected onto a non-interactive display surface or delivered to students on handouts. In either case, the instructor interacts with the administration application via the monitor of the host computer 52.

Those of skill in the art will appreciate that although a single classroom employing the participant response system 50 has been shown, in a typical education environment, participant response systems are employed in many, if not all classrooms of the educational institution. Of course, the participant response system 50 may be used in other environments where individuals are required to input responses to be processed.

As described above, the participant response system 50 provides for various advantages that achieve greater operability and user-friendliness. For example, one of the advantages is that all questions and answers are preferably broadcast from the teacher to the students. Logged-in students will thus receive the test and answers. Each student can then work at his/her own pace, and that pace is preferably not controlled by the teacher. Preferably, the teacher cannot set software-controlled time limits for responses from either the whole class or from an individual student, so each student can advance at a comfortable pace. Furthermore, since the students preferably cannot provide narrative responses, tests will be more efficiently conducted. Another advantage is that the participant response system 50 preferably does not allow the student to operate more than one interactive program at a time. This keeps the student's attention focused on the test at hand. Further, the remote units 62 preferably do not decode a teacher data packet that includes a plurality of characters, a portion of which pertain to different remote units. Also, since the IEEE802.15.4 specification is used, which implements a direct sequence spread spectrum modulation scheme, the communication link from the teacher is not subject to variation in timing between the rising and falling edges of the signal. Thus, the remote units 62 are less susceptible to interference and RF noise.

Furthermore, the host computer 52 persistently stores partial test results until the entire test is complete. Preferably, an open session between students and teacher is maintained until the test is complete. In no case is information from one test section included in information regarding another test section transmitted to the teacher. This gives each student greater flexibility in responding to the test, and increases the robustness of the communication protocol. In the participant response system 50, preferably, the remote units 62 do not immediately transmit each student keystroke of a multi-character response without waiting for the next keystroke. The entire response is sent when completed. Preferably, the participant response system 50 cannot be used in a multi-teacher environment, to avoid confusion in which the teacher has control over the test. Also, when authoring a test, the teacher does not place answers in an answer buffer, does not strip answers from a message, and does not leave a designated blank space in place of each answer or selected character.

In the participant response system 50, the remote units 62 do not store an application-specific text file, and they are not programmed to be used for a plurality of different applications solely by modifying such an application-specific text file. Likewise, the remote units 62 do not have any structure or function for identifying a particular one address word (assigned to that particular remote unit) from a list of address words sequentially broadcast by the teacher; nor does the host computer 52 have any structure or function for performing such a broadcast. These provisions allow greater flexibility in the tests the teacher can author and administer in the network communications structure and test distribution architecture.

Although embodiments have been described above with reference to the accompanying drawings, those of skill in the art will appreciate that variations and modifications may be made without departing from the spirit and scope thereof as defined by the appended claims.

1. In a participant response system comprising at least one host computer and a plurality of wireless, remote units communicating wirelessly with said host computer using a radio packet protocol, a method of reducing communications bandwidth during transmission of data messages between said host computer and said remote units, said method comprising: bundling data messages destined for substantially all remote units in general broadcast frames and transmitting said general broadcast frames to all of said remote units for processing by said remote units; transmitting data messages destined for one or more selected remote units in message frames addressed to said one or more selected remote units asynchronously; and transmitting data messages from remote units destined for said host computer in message frames asynchronously.

2. The method of claim 1 wherein said general broadcast frames are transmitted at generally equal intervals.

3. The method of claim 2 wherein said intervals are equal to or less than about 300 ms.

4. The method of claim 1 wherein said general broadcast frames are synchronization frames.

5. The method of claim 4 wherein said synchronization frames are beacon frames in accordance with the beacon mode defined by the IEEE802.15.4 specification.

6. The method of claim 1 wherein said bundled data messages are destined for all of said remote units.

7. The method of wherein said message frames are transmitted according to a carrier sensed, multiple access and collision avoidance scheme.

8. The method of claim 1 wherein during said bundling at least one of command messages and status messages are bundled into said general broadcast frames.

9. The method of claim 8 wherein each command message is selected from the group comprising log-in messages, log-out messages, log-in grant messages, question download messages, answer download messages, answer upload messages, hands-up messages, test start messages and test end messages.

10. The method of claim 8 wherein each status message is selected from the group comprising remote unit status messages, network status messages and personal area network (PAN) ID messages.

11. A method of transmitting data messages between a base unit and a plurality of hand-held units over a wireless communications link, said method comprising: embedding data messages addressed to substantially all of said handheld units into synchronization frames and broadcasting the synchronization frames at intervals to said hand-held units; transmitting data messages addressed to selected hand-held units in message frames asynchronously; and transmitting data messages from remote units addressed to said host computer in message frames asynchronously.

12. The method of claim 11 wherein said synchronization frames are transmitted at intervals less than or equal to 300 ms.

13. The method of claim 11 wherein said message frames are transmitted according to a carrier sensed, multiple access and collision avoidance scheme.

14. The method of claim 11 wherein during said embedding at least one of command messages and status messages are embedded into said synchronization frames.

15. The method of claim 14 wherein each command message is selected from the group comprising log-in messages, log-out messages, log-in grant messages, question download messages, answer download messages, answer upload messages, hands-up messages, test start messages and test end messages.

16. The method of claim 14 wherein each status message is selected from the group comprising remote unit status messages, network status messages and personal area network (PAN) ID messages.

17. In a system comprising a base unit and a plurality of remote units communicating wirelessly with said base unit, a data transmission method comprising: examining each data message to be transmitted by said base unit to determine if the data message is to be processed by substantially all of said remote units; if so, incorporating the data message into a synchronization frame destined for transmission to all of said remote units and transmitting said synchronization frame; if not, transmitting the data message in a message frame addressed to the remote unit(s) that is(are) to process the data message asynchronously; and transmitting the response data message(s) from the remote unit(s) addressed to said host computer in a message frame asynchronously.

18. The data transmission method of claim 17 wherein synchronization frames are transmitted at intervals less than or equal to 300 ms.

19. The data transmission method of claim 17 wherein each message frame is transmitted according to a carrier sensed, multiple access and collision avoidance scheme.

20. The data transmission method of claim 17 wherein the incorporated data message is at least one of a command message and a status message.

21. The method of claim 20 wherein each command message is selected from the group comprising log-in messages, log-out messages, log-in grant messages, question download messages, answer download messages, answer upload messages, hands-up messages, test start messages and test end messages.

22. The method of claim 20 wherein each status message is selected from the group comprising remote unit status messages, network status messages and personal area network (PAN) ID messages.

23. The data transmission method of claim 17 wherein said synchronization frames are beacon frames in accordance with the beacon mode defined by the IEEE802.15.4 specification.

24. A participant response system comprising: at least one host computer; and a plurality of remote units communicating wirelessly with said host computer using a radio packet protocol, wherein during communications between said host computer and said remote units, data messages from said host computer to be processed by substantially all of said remote units are transmitted to said remote units in general broadcast frames destined for all of said remote units and data messages from said host computer to be processed by selected ones of said remote units are transmitted to the selected ones of said remote units in message frames destined for those selected ones of said remote units asynchronously and wherein data messages from said remote units to be processed by said host computer are transmitted in message frames asynchronously.

25. A participant response system according to claim 24 wherein said general broadcast frames are transmitted at intervals equal to or less than about 300 ms.

26. A participant response system according to claim 24 wherein said general broadcast frames are synchronization frames.

27. A participant response system according to claim 24 wherein said synchronization frames are beacon frames in accordance with beacon mode defined by the IEEE802.15.4 specification.

28. A participant response system according to any one of claim 24 wherein said message frames are transmitted according to a carrier sensed, multiple access and collision avoidance scheme.

29. A participant response system according to claim 24 wherein data messages incorporated into the general broadcast frames comprise at least one of command messages and status messages.

30. A participant response system according to claim 29 wherein each command message is selected from the group comprising log-in messages, log-out messages, log-in grant messages, question download messages, answer download messages, answer upload messages, hands-up messages, test start messages and test end messages.

31. A participant response system according to claim 29 wherein each status message is selected from the group comprising remote unit status messages, network status messages and personal area network (PAN) ID messages.
